(19) United States
(12) Patent Application Publication
(10) Pub. No.: US 2007/0264976 A1
(43) Pub. Date: Nov. 15, 2007

(54) Portable device with short range communication function

(75) Inventors: Simon Lessing, BarsebacK (SE); Sofia Brostrom, Lund (SE)

Correspondence Address: ALBIHNS STOCKHOLM AB, BOX 5581, LINNEGATAN 2, SE-114 85 STOCKHOLM; SWEDENn, STOCKHOLM, omitted

(73) Assignee: Sony Ericsson Mobile Communication AB, Lund (SE)

(21) Appl. No.: 11/277,953

(22) Filed: Mar. 30, 2006

(51) Int. Cl. H04Q 7/38; H04Q 7/22; H04M 3/42

(52) U.S. Cl. 455/414.1

(57) ABSTRACT

The invention relates to a portable device (1A) with a short range communication feature, and more particularly a portable device such as a mobile telephone having a man-machine interface enabling user friendly use of short range communication. With the present invention an item (6) may be selected and dragged on the display (2), e.g. towards another apparatus (1B). This action initiates an automatic data transfer procedure using short range communication.

### FIELD OF THE INVENTION

The present invention relates to a portable device with a short range communication feature, and more particularly a portable device such as a mobile telephone having a man-machine interface enabling user friendly use of short range communication.

### BACKGROUND OF THE INVENTION

Portable devices such as mobile telephones and personal digital systems etc are often provided with means for direct communication with peripheral equipment and other devices, over a short range. In the case of mobile telephones, this direct communication is in addition to the normal communication over telecommunications networks. This short range channel may be used for sharing information with other users and devices. Data in one device, containing information about images, audio and video files, calendar and phone book information etc, is sent from one device to another over the short range channel. In this way, data may be shared by the two devices.

In a conventional sharing procedure, a user has to perform several actions to perform the data transfer. Typically, the user selects an item in a menu, selects send item, selects communication method or channel, and possibly activates the short range function. Thus, there is a need for a simplified procedure.

Near field communication as such is previously known. There exist several techniques, such as NFC, near field communication using RFID, radio frequency identification, short range radio (Bluetooth™), and communication by means of infrared light.

With NFC, a communication channel for exchange of data is established automatically as soon as two devices are placed close to each other. With short range radio and infrared light the user often has to select the communication method, and then the device tries to establish communication with another device located in the vicinity.

### SUMMARY OF THE INVENTION

An object of the present invention is to provide a simplified procedure for establishing short range communication and transfer data. With the present invention an item may be selected and dragged on the display, e.g. towards another apparatus. This action initiates an automatic data transfer procedure using short range communication.

The invention provides a portable device comprising:

a storage means for storing items containing data;
a user interface having display means for displaying an item, and having navigation means for inputting commands to a control unit;
a communication interface capable of establishing a short range communication channel with another device;
a control unit configured to receive commands from the navigation means, to control the display means and the communication interface, and to store and retrieve items in the storage means.

According to the invention, the control unit is configured to interpret a command for moving a representation of an item towards an edge of the display means as a command to send data associated with the item to the other device.

In one embodiment, the navigation means comprises a navigation device separate from the display means.

The navigation device may comprise a joystick and/or navigation keys.

In another embodiment, the navigation means is integrated with the display means.

The display means may comprise a touch screen.

The communication interface may be capable of establishing the communication channel by means of RFID, radio frequency identification.

In one embodiment, the device is configured to activate the communication interface, and to establish a near field communication channel with another device, automatically as soon as another device within RFID communication range is detected.

The communication interface may be capable of establishing the communication channel by means of short range radio, such as Bluetooth™.

In one embodiment, the device is configured to activate the communication interface, and to establish a near field communication channel with another device, automatically as soon as another device within short range radio communication range is detected.

The other device may be detected by means of RFID, radio frequency identification.

The communication interface may be capable of establishing the communication channel by means of infrared light.

The device may be a mobile telephone, a pager, a communicator, a smart phone, or an electronic organiser.

### BRIEF DESCRIPTION OF THE DRAWINGS

The invention will be described in detail below with reference to the accompanying drawings in which:

FIG. 1 is a view of a typical mobile telephone, which may incorporate the present invention,

FIG. 2 is a schematic diagram of components involved in the present invention, and

FIGS. 3A-3E illustrate different steps of a transfer procedure according to the invention.

### DETAILED DESCRIPTION OF PREFERRED EMBODIMENTS

The invention is described with reference to a portable device, e.g. a telecommunication device such as a mobile telephone, a pager, a communicator, or a smart phone. The invention is equally applicable in other computer devices, such as electronic organisers, palm computers et cetera.

A person skilled in the art will realize that the device may incorporate many other functions and components. This specification will focus on components relevant to the invention, while other components may be conventional.

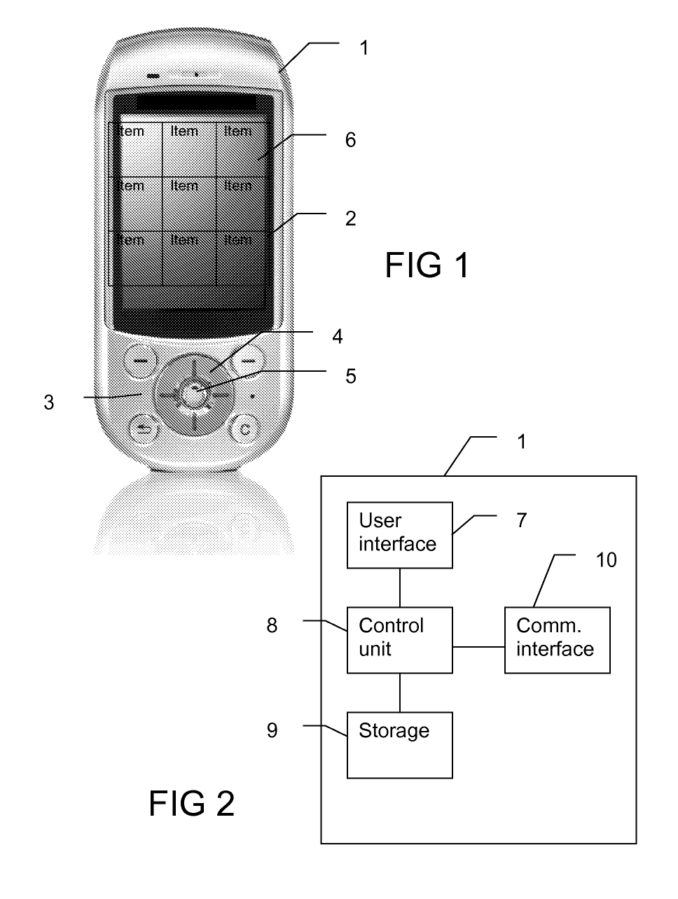

FIG. 1 illustrates a typical mobile telephone 1 with a display 6 and navigation means 3. The navigation means may be separate from the display as illustrated with a ring 4 and a center button 5. Other navigation devices are possible, such as a joystick, a ball element and direction buttons et cetera.

The navigation means may also be integrated with the display. In this case, the display suitably comprises a touch screen, i.e. a screen sensitive to touches by a finger or a stylus for receiving commands from the user who touches and drags on the screen to perform various operations. Touch screens are commercially available components and do not form part of the present invention as such.

The device 1 comprises storage for storing data relative to images, audio and video files, calendar entries, phone book information et cetera. In this specification such data files are referred to as items. An item is associated with data that may be shared. When sharing an item a copy of the data is sent, while maintaining the original data in storage. As is conventional, items may be handled by navigating in a menu system of the device. Typically, a number of items are represented by icons, thumb nails or other symbols. In FIG. 1 nine items are represented schematically and denoted by number 6.

The device is illustrated schematically in FIG. 2. The device 1 comprises a user interface, comprising display means and navigation means as discussed above. The storage means is denoted by reference numeral 9.

The device also comprises a communication interface 10 for handling short range communication. The communication interface 10 comprises transmitters and receivers for communicating with NFC using RFID, radio frequency identification, short range radio, such as the well known Bluetooth system, and/or for communication via infrared light.

The NFC protocol is based on a wireless interface. The protocol establishes wireless network connections between network appliances such as mobile phones and consumer electronics devices or between two mobile phones.

The interfaces suitably operate in the unregulated RF band of 13.56 MHz. In practice the distance at which the devices can connect to each other is restricted, and the operating distances are usually in the range of 0˜20 cm.

As is often the case with the devices sharing a single RF band, the communication is half-duplex. The devices implement the “listen before talk” policy—any device must first listen on the carrier and start transmitting a signal only if no other device can be detected transmitting.

NFC protocol distinguishes between the Initiator and the Target of the communication. Any device may be either an Initiator or a Target. The Initiator, as follows from the name, is the device that initiates and controls the exchange of data. The Target is the device that answers the request from the Initiator.

The NFC protocol also distinguishes between two modes of operation: Active mode and Passive mode. All devices support both communication modes. The distinction is as follows:

In the Active mode of communication both devices generate their own RF field to carry the data.

In the Passive mode of communication only one device generates the RF field while the other device uses load modulation to transfer the data. The protocol specifies that the Initiator is the device responsible to generate the RF field.

According to the NFC standard, the application sets the initial communication speed at 106, 212 or 424 kbit/s. Subsequently the application and/or the communication environment may require speed adaptation, which can be done during communication.

The communication is terminated either on the command from the application or when devices move out of range.

Also, the NFC protocol can be used easily in conjunction with other protocols to select devices and automate connection set-up. The parameters of other wireless protocols can be exchanged allowing for automated set-up of other, longer-range, connections. The difficulty in using relatively long-range protocols like Bluetooth or Wireless Ethernet is in selecting the correct device out of the multitude of devices in the range and providing the right parameters to the connection. Using NFC the whole procedure is simplified to a mere placement of one device close to another.

The device 1 is provided with a control unit 8, having a processor for handling commands from the user interface and is operating in accordance with software or code to control operations of the device including the interfaces and data handling.

The operation of the device results in easy sharing of data between the device and other devices located in the near field. The near field communication is typically capable of operating over short distances, e.g. within a few centimeters for NFC (RFID) and infrared light, and a normal room for short range radio (e.g. Bluetooth). An object of the invention is that users should go through as few steps as possible, and use a procedure that is as intuitive as possible. The invention allows users to use a simple gesture for sharing data, bypassing the need to find and select actions in the interface. Basically, the user of a touch screen phone can simply use a finger/pen to touch and drag an item to be shared in the direction of the other phone. When he reaches the edge of the screen, a question will pop-up: “Send to yyy phone?” In case of NFC and short range radio, it does not matter in which direction the other user's phone is as long as the devices are within range for communication. The user will intuitively drag the item in the direction of the other user's phone, but in reality it could work equally well to drag the item in any direction on the display. In case of infrared light, however, the transmission and reception port is located at one side of the device. Thus, the user interface should encourage the user to place the device correctly by allowing communication only when the user has dragged an item on the display in the direction of the infrared light port of the user's phone.

In a phone without a touch screen, the user can use the navigation means 3 to the same effect—hold and press “right” on an item if the other phone is to the right, “left” if to the left, “up” if above. Long presses may be necessary to differentiate sharing from other navigation with the navigation means depending on the layout of the items on the display.

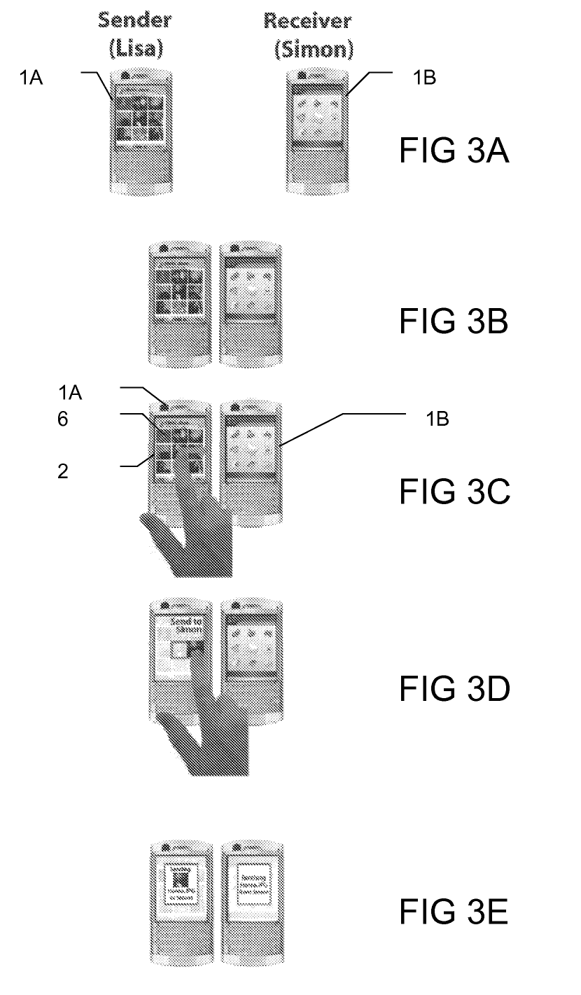

A typical example of a sharing procedure according to an embodiment of the invention is shown in FIGS. 3A-3E. The sender phone 1A is shown to the left, and the receiver phone 1B is shown to the right.

Step 1, FIG. 3A: The sender, Lisa, wants to send a picture to a receiver, Simon, using NFC.

Step 2, FIG. 3B: Both phones are placed at a suitable distance and position, and Lisa and Simon make sure that their NFC systems are in an activated mode. In some of the current phones, the NFC systems are activated automatically as soon as they are placed within a suitable range. For example, two NFC or Bluetooth units may establish a connection and pair themselves automatically. Alternatively, the identification of the other phone is achieved by means of NFC, and then a Bluetooth channel is established for the data transfer. This function may well be combined with the present invention.

Step 3, FIG. 3C: Lisa touches the picture 6 that she wants to send from her phone 1A to Simon's phone 1B and drags her thumb nail on the display 2 towards an edge of the screen, suitably in the direction of Simon's phone.

Step 4, FIG. 3D: Once Lisa's finger reaches the edge of the screen, a pop-up message appears on Lisa's screen asking “Send to Simon?” Lisa confirms the action. Possibly, the message only indicates what action will be performed without Lisa having to confirm it.

Step 4, FIG. 3D: The transfer is started once the finger is released. At the same time Lisa's phone displays a message “sending picture x to Simon” and a corresponding message is displayed on Simon's phone, saying “receiving picture x from Lisa”.

It will be seen that Lisa only has to perform one basic action—touch, drag and drop in one movement with her finger—to achieve the data transfer. This results in a simplified and user-friendly procedure. Note that the invention will only have to be implemented in the sender's phone, as the reception is conventional.

The invention may be implemented by means of a suitable combination of hardware and software. The scope of the invention is only limited by the claims below.

1. A portable device comprising:
a storage means for storing items containing data;
a user interface having display means for displaying an item, and having navigation means for inputting commands to a control unit;
a communication interface capable of establishing a short range communication channel with another device;
a control unit configured to receive commands from the navigation means, to control the display means and the communication interface, and to store and retrieve items in the storage means; wherein
the control unit is configured to interpret a command for moving a representation of an item towards an edge of the display means as a command to send data associated with the item to the other device.

2. A portable device according to claim 1, wherein the navigation means comprises a navigation device separate from the display means.

3. A portable device according to claim 2, wherein the navigation device comprises a joystick and/or navigation keys.

4. A portable device according to claim 1, wherein the navigation means is integrated with the display means.

5. A portable device according to claim 4, wherein the display means comprises a touch screen.

6. A portable device according to claim 1, wherein the communication interface capable of establishing the communication channel by means of RFID, radio frequency identification.

7. A portable device according to claim 6, wherein the device is configured to activate the communication interface, and to establish a near field communication channel with another device, automatically as soon as another device within RFID communication range is detected.

8. A portable device according to claim 1, wherein the communication interface capable of establishing the communication channel by means of short range radio, such as Bluetooth™.

9. A portable device according to claim 8, wherein the device is configured to activate the communication interface, and to establish a near field communication channel with another device, automatically as soon as another device within short range radio communication range is detected.

10. A portable device according to claim 9, wherein the other device is detected by means of RFID, radio frequency identification.

11. A portable device according to claim 1, wherein the communication interface is capable of establishing the communication channel by means of infrared light.

12. A portable device according to claim 1, wherein the device is a mobile telephone, a pager, a communicator, a smart phone, or an electronic organiser.
